(19) United States
(12) Patent Application Publication
(10) Pub. No.: US 2008/0288240 A1
(43) Pub. Date: Nov. 20, 2008

(54) Network-Based Translation System And Method

(76) Inventor: Giovanni D'Agostini, Udine (IT)

Correspondence Address: ST. ONGE STEWARD JOHNSTON & REENS, LLC, 986 BEDFORD STREET, STAMFORD, CT, 06905-5619, US

(21) Appl. No.: 12/112,408

(22) Filed: Apr. 30, 2008

Related U.S. Application Data
(63) Continuation of application No. PCT/EP2005/011769, filed on Nov. 3, 2005.

(51) Int. Cl. G06F 17/28

(52) U.S. Cl. 704/3

(57) ABSTRACT

A translation system of the type with a connecting structure with intercommunicating net/internet:, whose net includes a plurality of interconnected servers, includes: at least one net-communicator microprocessor user-apparatus for net communication which includes a connection to the net and/or via net/internet, and at least one net-service-server connected to the intercommunicating net/internet including an indefinite number of servers. The net service-server includes or connects to at least one netservice database. The system also includes a plurality of translator computers and/or translator-servers including at least one automatic translation system inside for a plurality of languages in various combinations.

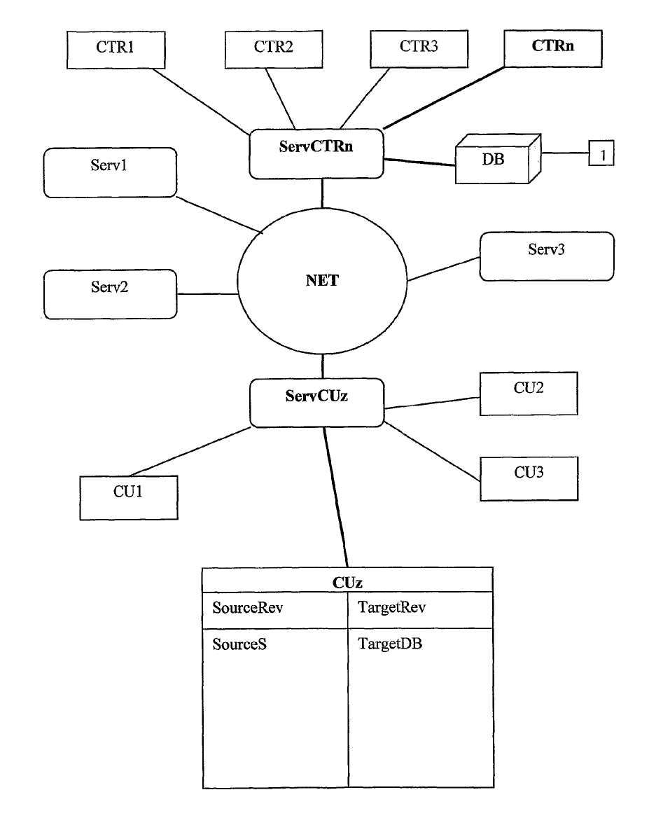

### CROSS-REFERENCE TO RELATED APPLICATIONS

The present application is a continuation of pending International patent application PCT/EP2005/011769 filed on Nov. 3, 2005 which designates the United States and the content of which is incorporated herein by reference.

### FIELD OF THE INVENTION

The present invention relates to a translation system, whose characteristics conform to the pre-characterizing part of the main claim. The method of translation is also part of the present invention.

### Use

The use is substantially directed to the fast translation of electronic texts, namely of texts available in electronic form to be processed by the computer.

### BACKGROUND OF THE INVENTION

The current background art includes a very large variety of systems and methods for the automatic translation by the computer.

Most of these methods can be divided substantially in two categories:

a) Resident translator: automatic translation carried out directly by computer by means of software residing in the same computer.

See WO 02/054280 A (D'AGOSTINI ORGANIZZAZIONE SRL; D'AGOSTINI GIOVANNI) 11 Jul. 2002 that disclose an autolearning translation system that memorizes and reuses instructionally-coded corrections including source language fragment, corresponding amended target-language fragment and respective instruction-code;

b) External translator: automatic translation carried out by another computer containing the translation software, therefore by means of the use of an external connecting net, e.g. Internet or Intranet. The user request is either directly connected to the interested translator or managed by a workflow manager that decide where to direct the request of the user: Eg. WO 00/46693A (LAKRITZ, DAVID) 10 Aug. 2000, discloses a translation management system to “detect a data stream or non-text file in the master language has been updated and notifies the user which corresponding documents, data streams, or non-text files if the other language require translation which are then staged and dynamically routed and sequenced by workflow manager, to individual translation resources where the actual translation is performed. Management status, reporting, scheduling and accounting information is sent to the user as the translation process ensues. The user is notified of the completion of translation and the invention coordinate the delivery of the translated documents, data streams or non text field back to the user's site for installation and optional review.” (see abstract)

There is also WO 01/18680A (RWS GROUP IIC) that refers to a Computer assisted Language translation that provides a network-based document management capabilities, storing documents on a server coupled to a network wherein a remote user may display selected portions of the original document on a remote network terminal, and the remote user may create a translation language document on the server.

### Problems and Drawbacks of the Background Art

The problems and drawbacks of the background art refer substantially to the fact that:

aa)—the solution a) that includes the translator with software residing in the computer, needs:
a high performance computer;
continuous update of the same software;
purchase of software and continuous update cost;
limitation of the performance of the software in relation to the limited capacity of the same computer or user-apparatus.

In fact, a portable computer or a pocket computer is limited in performance, the same is true for a palmtop. Mobile phone or cell-phones are also limited in performance for managing a translation. Actually, a palmtop or a cell-phone are not able to support a high quality translation system, both due to the limitation of memory and the microprocessor performance. In fact, the particularly advanced translation systems require very fast and powerful microprocessors and further require the same powerful PC-motherboards that certainly cannot be applied in the palmtops or cell phones, both due to size and problems of disposal temperature etc.

bb) the solution b) allowing entrance into in an external server by means of the network, e.g. access with the internet, has the advantage of not needing a translation system residing in the computer but provides two disadvantages:
the first refers to a danger from external intruders via the internet penetrating into the translator server and creating damage;
inability to provide a high quality translation, namely specialized, and therefore of a high level. This is due substantially to the fact that the server supplying such a service is not able to personalize the required translation or to promptly implement the quality. Furthermore, the user will then have to copy the translation to place it on traditional Word-Processing software for correction, with a large amount of time and energy being spent on the use of suitable specific instruments for specific post-editing after translation.

ab) both a) and b) cited solutions which are rigid, namely translation cannot easily be performed or improved for immediate future translation. Solution b) being practically impossible to improve for immediate future translations (Eg. Adding missing words—in German Language there are a lot—, improving sentences and fragments by teaching, etc.)

All these drawbacks, together with the generally low quality of the automatic translation mean that the majority of translators who want to produce a high quality translation still adopt the manual translation system, possibly assisted with a Word-Processor.

### SUMMARY OF THE INVENTION

### Score of the Invention

The scope of the invention is to solve the above-mentioned problems and drawbacks without other charges or costs and without reducing reliability, in order to allow the:
improvement of the working performance;
increase of the product quality namely the quality of the translation and the immediate future translation or retranslation;
reduction of the working time,
containing of the costs at a minimum,
operation at maximum safety, both for the user and the servers
prevention of access to externals, preventing damage and virus to translators and
ensurance at the same time the speed of service with low installation costs.

### Solution of the Problem and Disclosure of the Invention

The problem is solved with the characteristics of the main claim.

The sub-claims represent advantageous preferred solutions that provide optimal performance.

### Advantages

In this way a workflow manager of WO 00/46693 is not used because each translator itself when free, manage the available work from the Data Base. This solution avoiding complicate problems of managing external operators/translators. Furthermore the following advantages are obtained:
placing in a secure condition the translator servers so they cannot be contacted and/or identified by the user;
having constantly and rapidly improving translation due to:
   the use of an autolearning engine for a target language, inside a standalone user-terminal translation and
   the use of external servers that have notoriously better performance for continuous improving compared with a translation system residing in each computer of the users;
improving the performance of the whole work;
increasing final product quality;
remarkable reduction of the production time to obtain a very good finished product, namely of the translation and the revision;
remarkable reduction of the costs for the implementation of such a product without renouncing the required quality.
no limitations of use obliged by memory, microprocessor and sizes,
ability to also be used in small portable/pocket appliances, on small palmtop apparatuses or pocket or mobile/cell phones;
prevention of hacking, virus and spam intrusion,
damages free guaranteed, for the incommunicability and non-recognition of the user with respect to translator-server (the translator-server is random),
speed of the service being, the server-translator to casually capture the data to be translated (the first server-translator available will provide it), avoiding waiting times for translations in progress.
unlimited number of translator-servers, guaranteeing a secure service, being placeable in different sites and countries to avoid local casual stops;
use of inexpensive computer-server translator/s,
expensive super-fast computers or super-computers not being necessary;

### BRIEF DESCRIPTION OF THE DRAWINGS

For a better understanding, the invention is described in a preferred solution with the aid of the included schematic diagram, wherein:

The FIGURE represents a schematic view of the internetNETserver/s computer/palm/cell-phone structure for realizing the system, wherein (Cuz) is represented in larger size as one of the innumerable user-computers or palms or cell phones able to connect to the internet.

### DETAILED DESCRIPTION OF THE INVENTION

According to the FIGURE, it is observed that the system of the present invention requires a connecting structure to the internet whose net includes a plurality of interconnected servers (Serv1.Serv2.Serv3 . . . ServCUz), in which is provided:

a) at least one communicator user-apparatus with microprocessor (Cuz) for communication by net (CU1, CU2, CU3 . . . CUz) which comprises connecting means to the Internet/NET (ServCTRn-NET), Eg. PC, palm, cell-phone etc., and

b) at least one NET-server or internet service-server (ServerCTRn) connected to said intercommunicating net/internet (NET) comprising an indefinite number of servers (Serv1.2 . . . );

c) said service-server (ServerCTRn) being connectable at least on one net-service database (Db); and

d) a plurality of translator-computers and/or translator-servers (Ctrn) comprising at least one in-side system of automatic translation for a plurality of languages in various combinations, said translator-computer and/or translator-server (Ctrn) including furthermore:
i. connecting means to said net/internet (ServCUz-net) and
ii. automatic and repetitive supervision means to inspect periodically said c) net-service database (Db) to verify if data and text to be translated are loaded in said net-service database,
iii. means of respective withdrawal/download at least said data text to be translated (SourceS),
iv. means for automatically translating said text to be translated (SourceS) to obtain a translation (TargetDB) and
v. means for sending automatically said translation (TargetDB) in said net-service database (Db), and to continue the inspection for new texts in said net-service database (Db);

e) said communicator apparatus a) (Cuz), including similarly:
i. means of sending data and said text to translate (SourceS) in said c) net-service database (Db),
ii. means for inspecting periodically said net-service database to verify if the respective translation has arrived (TargetDB), and
iii. means for respective withdrawal/download of said translation (TargetDB),

f) so that said communicator user-apparatus (Cuz) can communicate for input data and sending the source-text to carry out translation and receive the completed translation, only and exclusively with said c) net-service database (Db), of said service-server (ServerCTRn);

g) and so that said translator-computer and/or translator-server (Ctrn) communicate for introducing and taking data, in the phases of withdrawal and translation delivery only, and only with said c) net-service database (Db) of said service-server of net b) (ServerCTRn),

h) said net service-server d) (ServerCTRn) including stopping means or being without means which allow the direct connection between said communicator user-apparatus a) (Cuz) and said translator-computer and/or translator-server d) (Ctrn);

In this way it is understood that the translation service is carried out:

with an acceptable speed but without communication or connection between the user (Cuz) and the casual translator-computer/translator-server (Ctrn), namely the one available,

but not in the same moment, because the decision depends on the latter and not on the former.

The advantages are therefore evident in:

saving waiting time,

safety against hackers and virus or ill-intentioned individuals, etc. though always ensuring speed and maximum safety and quality.

With this invention, advantageously the user-computer or computer of the user (represented in larger size in FIGURE Cuz) includes two pairs of scrolling fields respectively:

a—the lower couple representing on the left the text to be translated (SourceS) and on the right the translated text (TargetDB) downloaded from the said net-service database (Db) which in turn received the translation from said random translator-computer/translator-server (Ctrn) and

b—the upper couple representing the couple of the revised portion of texts, said texts being passed line-by-line from the lower couple to the upper couple by an operator-command action after having carried out line-by-line check and correction. The upper couple representing therefore the:
target text completely amended and revised of the translation (TargetRev) on the right, and
the corresponding original source text used for the translation (SourceRev) on the left,

this occurs by means of parallel transfer control from the lower couple to the upper couple in an equal number of paragraphs (lines) on a case-by-case basis, from the lower couple to the upper couple until the end of the revision.

### Auto-Learning and Auto-Improving During Correction and Revision

As stated above it was till now practically impossible to auto-learn for immediately auto-improving translation, if machine translation process has been performed on-line by a different unknown standalone server.

With this invention an auto-learning engine is provided inside in order to memorize at least Target-Language corrections to be reused immediately and continuously without waiting for better performance of the Translator-Server.

### Correction Instruments

The User system advantageously includes memory means of the corrections carried out and storage of said corrections at least for exit/target language/s in which the incorrect sentence fragment of the automatic translation and the corresponding correction in the same exit/target language is memorized.

In this way, an automatic memorisation of the corrections is created automatically. It can be automatically reused for any following translation in the same exit target-language and with the advantage of being independent of the source language, so working also for other different translation couples of languages.

With this method the following is obtained:

the memory size is reduced;

the same teachings are used independently of the source language, so as an example, if the translation, namely the exit target language is Italian, the correction will occur independently of the fact that the source language is different: English, German, French, Spanish or Portuguese, etc., and such correction/s work/s immediately for all future immediate translations without waiting for better performance of the Translator-Server.

This will naturally improve the quality of the translation and automatically correct the errors also made by the automatic translator arriving via the Internet.

In other words Eg. if the correction for Italian Target language is from “la cane” to “il cane”, this correction will be valid for any source language because the correction occurs only and exclusively in the exit target-language, namely in this specific case in the Italian language. Since it is accumulated automatically in a stable memory it will be reused indefinitely unless the operator wishes to delete it.

The advantage of this kind of method and process is evident, largely reducing amendments and the size of instructions for different language couples, said instructions about language couples being used by the translator-computer or translator-server and not by the user-computer.

Advantageously the translation-computer or translator-server presents an optional translation system that includes:

activation means of automatically continuous and repetitive surveillance in said net-service database (Db), and in that case depending on the instructions received in Db from the user:
to decide between automatic translation or
to send the document to be translated for interactive translation with operator control to provide a computer translation checked by a human being;
deactivation means of said automatic check and activation means of interactive translation with operator control.

In this way it is understood that it is possible to supply to the user:

i. automatically a purely automatic machine translation to be used for understanding or for following revision or correction by the user,

ii. semi-automatically a quality translation at a maximum level as it has already been checked by an operator and therefore by a human being.

Substantially said net translator server (Ctrn) is endowed with:

automatic translation means and

semi-automatic interactive translation means with post-editing means connected to auto-learning engine that, in relation to the source-text, memorizes corrections performed by the operator for immediate reuse in the prosecution of the translation, and

option translation means for:
a—activation of automatic continuous and repetitive surveillance in said net-service database (Db), and in that case depending on the received instructions from the user in said net-service database (Db) for performing automatic translation or
b—deactivation means of said automatic surveillance making the computer translator server (Ctrn) able to operate with said semi-automatic interactive translation means with operator control, so that it is possible to supply to the user:
I. automatically a purely automatic machine translation,
II. semi-automatically a human quality translation already checked by an operator in the respective interactive translation.

### Process

The translation process occurs as follows:

a) a user in a computational system with net-communicator user-apparatus (Cuz), introduces at least the following data:
the source language,
the target language and
the text to translate (SourceS),
working domain introduction being optional;

b) the translation request is sent by net to a net service-server (ServCTRn) connected to said net-service database (Db);

c) said Db by means of said web server (ServCTRn) controls the access of the data of said user and if acceptable, it will allow the insertion in the same net-service database, otherwise it refuses access;

d) in the case of data insertion into said net-service database (Db), one of the translator-computers/translators-servers (Ctrn) on stand-by available at that moment, looking at the new job available will intervene taking said data and providing the task according to the instructions supplied by said data to carry out an automatic or interactive translation,

e) after performing the translation, the translation is sent to said net-service database (Db) and remains on a net-service database (Db) until the user intervenes to download the translation.

After the previous working, the following features are provided:

a) a net-communicator user-apparatus (Cuz) with translation post-editing device is used, said translation post-editing device having two over-posed couples of parallel scrolling fields (SourceRev-TargetRev, SourceS-TargetDB) and

b) after taking-on/download, the translation and requiring its revision, said translation is placed on the right field (TargetDB) of a lower couple of said two over-posed couples of fields to allow the following steps:
i. check line by line if the translation is correct, carrying out the corrections in said revision text on the lower right field (TargetDB) with respect to the corresponding paragraph of the left field source text (SourceS);
ii. by means of change-detector automatic auto-learning means, prearranged in said net-communicator user-apparatus (Cuz) the wanted carried out corrections are automatically memorized for immediate re-use in following sentences and in following future translations;
iii. the upper sentences/lines couple/s of the revised right and left texts in said couples of lower fields (SourceS, TargetDB), being transferred in continuation to an upper couple of text-checked fields (SourceRev.TargetRev), namely in continuation of the texts already checked and amended;
iv. the cycle repeats until the end;
v. at the same end of the revision, the whole revised text, both source on the left and target on the right are ready for use on said upper couple (TargetRev, SourceRev.TargetRev).

Advantageously, after completion of the revision,

a)—sending means automatically open an EMail provided to send the corrections, mistake and correction, to a predetermined destination section with the task of improving the translation system so that these errors will be considered in future releases, while the system of the user already uses said corrections already stored in memory,

b)—in a separate and independent step the mailed corrections opportunely valued will be inserted into future releases destined to replace the translator of respective translator-computer/translator-servers (Ctrn).

Advantageously a DATA-control means (1) is provided to control said net-service database (Db) in order to allow or not, entering or downloading data from it to and from said:

a) net-communicator microprocessor user-apparatus (Cuz) and

d) translator-computers and/or translator-servers (Ctrn)
the a) net-communicator microprocessor user-apparatus (Cuz) being controlled for respecting at least:
   I—limit of number of words allowed per user-time allowed:
   II—user-time lapse.

In this way the managing of the whole system is really facilitated and controlled automatically by the DB and also manually controlled by a single operator.

### Summary of the Components of the System and Terminology:

1) net-communicator user-apparatus (Cuz), intended as computer or palmtop or mobile phone and for allowing the user to send and receive texts and data at least via internet or similar;

2) net service-server (ServerCTRn), intended as a server connected to internet net or similar;

3) net-service database (Db) accessible from said net service-server (ServerCTRn), intended as a database for data memorisation with control means and authorization of access means for introducing DATA into said database and/or downloading DATA from said database, said net-service database (Db) being able to reside in said net service-server (ServerCTRn) or in another net remote server (Serv.1, Serv2, Serv3) connectable to said net service-server (ServerCTRn);

4) translator-computer and/or translator-server (Ctrn), comprising an automatic and interactive machine translation inside and further comprising connecting means to said net-service database (Db) to:

take/download data from said net-service database (Db),

carry out automatic and/or interactive translations of texts included in the download and

send back the translations to said net-service database (Db).

Advantageously access to Database will be allowed by password, in this way a better control of the users will be performed.

1. Translation system of the type with a connecting structure with intercommunicating net/internet, whose net includes a plurality of interconnected servers, characterised in that it comprises:
a) at least one net-communicator microprocessor user-apparatus for net communication which comprises connecting means to the net and/or via net/internet, and
b) at least one net-service-server connected to said intercommunicating net/internet comprising an indefinite number of servers;
c) said net service-server including or connecting to at least one net-service database;
d) a plurality of translator-computers and/or translator-servers comprising each at least one automatic translation system inside for a plurality of languages in various combinations;
e) said net-communicator user-apparatus a) including similarly:
I. means of sending data and said text to translate in said c) net-service database,
II. means for detecting said net-service database and verifying if the respective translation has arrived, and
III. means of respective taking-on/download of said translation from said c) net-service database,
f) so that said net-communicator user-apparatus can communicate, to introduce data and send the translation to carry out and receive the completed translation, only and exclusively with said c) net-service database;
Characterised in that:
each of said translator-computer and/or translator-server includes:
I. connecting means to said intercommunicating net/internet and
II. automatic and repetitive supervision means to verify if at least one text to be translated is loaded in said c) net-service database,
III. means of respective taking-on/download from said c) net-service database of said text to be translated,
IV. means for translating at least automatically said text to be translated to obtain automatically a translation and
V. means for sending automatically said translation into said net-service database, and to continue the inspection for new texts in said net-service database;
VI. said translator-computer and/or translator-server communicate to introduce and capture data, in the taking-on/download and translation delivery phases only with said c) net-service database, h) said net service-server d) including stopping means or being without means allowing the direct connection between said net-communicator user-apparatus a) and said computer and/or net translator server d);
and wherein said features a),b),c),d),e),f),g),h), are organised in order to allow at least the following process:
i) a user in a computational system with said net-communicator user-apparatus, introduces at least the following data:
the source language,
the target language and
the text to translate,
ii) the translation request is sent from the said user-apparatus by net to a net service-server connected to said net-service database;
iii) said database by means of said web server control the access of the data of said user and if acceptable, it will allow insertion of said data, otherwise access is refused;
iv) in the case of data insertion in said net-service database, one of the said translator-computers/translators-servers on stand-by available at the moment, looking at the new jobs available will intervene taking said data and providing the task according to the instructions supplied by said data in said database for carrying out an automatic or interactive translation,
v) after performing the translation, the translation is sent from the said translator-computers/translators-servers to said net-service database for being used by said user-apparatus.

2. Translation system according to claim 1, characterised in that said net-communicator user-apparatus is a computer.

3. Translation system according to claim 1, characterised in that said net-communicator user-apparatus is a palmtop.

4. Translation system according to claim 1, characterised in that said net-communicator user-apparatus is a mobile phone or cell-phone.

5. Translation system according to claim 1, characterised in that said net-communicator user-apparatus is a computer with auto-learning means for memorizing the incorrect sentence fragment of the translation and its correction for the following reuse.

6. Translation system according to claim 1, characterised in that said net-communicator user-apparatus is a computer with:
i—auto-learning means for memorizing the incorrect sentence fragment of the translation and its correction and
ii—automatic or semi-automatic transfer means via EMail of said corrections at least of the revision of each revised text.

7. Translation system according to claim 5, characterised in that said corrections include also the corresponding portion of the original text to be translated.

8. Translation system according to claim 1, characterised in that said net user-computer includes two pairs of scrolling fields respectively:
the lower couple representing on the left the text to be translated and on the right the translated text taken-on/downloaded from said net-service database which in turn received the translation from said random translator-computer/translator-server and
the upper couple that is the couple of revised texts coming from the lower couple by means of action-command by the operator after having carried out line-by-line the check and correction and representing therefore:
i. the text completely amended and revised of the translation on the right and
ii. the corresponding original text used for the translation on the left,
the above upward movement occurring by means of parallel transfer action from the lower couple to the upper couple in equal number of paragraphs, namely line by line, on a case-by-case basis from below to above until the end of the revision.

9. Translation system according to claim 1, characterised in that said net translator server is endowed with:
automatic translation means and
semi-automatic interactive translation means with post-editing means connected to auto-learning engine that, in relation to the source-text, memorizes corrections performed by the operator for immediate reuse in the prosecution of the translation, and
option translation means for:
a—activation of automatic continuous and repetitive surveillance in said net-service database, and in that case depending from the received instructions from the user in said net-service database for performing automatic translation or
b—deactivation means of said automatic surveillance making the computer translator server able to operate with said semi-automatic interactive translation means with operator control, so that is possible to supply to the user:
I. automatically a purely automatic machine translation,
II. semi-automatically a human quality translation already checked by operator in the respective interactive translation.

10. Translation method utilizing the system of claim 9, characterised by the following stages:
a) a user in a computational system with net-communicator user-apparatus introduces at least the following data:
the source language,
the target language and
the text to translate,
working domain introduction being optional;
b) the translation request is sent from the said user-apparatus by net to a net service-server connected to said net-service database;
c) said database by means of said web server control the access of the data of said user and if acceptable, it will allow insertion into said net-service database, otherwise access is refused;
d) in the case of data insertion in said net-service database, one of the translator-computers/translators-servers on stand-by available at the moment, looking at the new job available will intervene taking said data and providing the task according to the instructions supplied by said data for carrying out an automatic or interactive translation,
e) after performing the translation, the translation is sent from the translator-computers/translators-servers to said net-service database and remains on the net-service database until the said net-communicator user-apparatus downloads the translation.

11. A translation system according to claim 1, characterized in that a DATA-control means is provided to control said net-service database in order to allow or not entering or downloading data from it to and from said:
a) net-communicator microprocessor user-apparatus and
d) translator-computers and/or translator-servers
the a) net-communicator microprocessor user-apparatus being controlled for respecting at least:
I—the limit of number of words allowed per user-time allowed:
II—user-time lapse.

12. Translation method according to claim 11, characterized in that:
a) a net-communicator user-apparatus with a translation post-editing device is used, said translation post-editing device having two over-posed couple of parallel scrolling fields and
b) after taking-on/download, the translation and requiring its revision, said translation is placed on a right field of a lower couple of said two over-posed couple of fields for allowing the following steps:
i. check line by line if the translation is correct, making the corrections in said text under revision on the lower right field with respect to the corresponding paragraph of the left field source text;
ii. by means of change-detector automatic auto-learning means, prearranged in said net-communicator user-apparatus the required carried out corrections are automatically memorized for immediate re-use in following sentences and in following future translations;
iii. the upper sentences/lines couple/s of the revised right and left texts in said couples of lower fields, being transferred in continuation of checked and amended texts. in an upper couple of text-checked fields;
iv. the cycle repeats until the end;
v. at the same end of the revision, the whole revised text, both source on the left and target on the right are ready to use on said upper couple.

13. Translation method according to claim 12, characterized in that after completion of revision,
a)—sending means automatically open an EMail to send the mistakes and respective corrections, to a predetermined destination section with the task of improving the translation system so that these errors will be considered in future releases, while the system of the user already uses said corrections already stored in the memory as an autolearning engine,
b)—in a separate and independent step the mailed corrections opportunely valued will be inserted in future releases destined to replace the translator of respective translator-computer/translator-servers.

14. Translation system according to claim 6, characterised in that said corrections include also the corresponding portion of the original text to be translated.
